(19) United States
(12) Patent Application Publication
(10) Pub. No.: US 2005/0050385 A1
(43) Pub. Date: Mar. 3, 2005

(54) Server crash recovery reboot auto activation method and system

(76) Inventor: Chih-Wei Chen, Taipei (TW)

Correspondence Address: FULBRIGHT AND JAWORSKI L L P;PATENT DOCKETING 29TH FLOOR, 865 SOUTH FIGUEROA STREET, LOS ANGELES, CA, 900172576, US

(21) Appl. No.: 10/647,970

(22) Filed: Aug. 26, 2003

(51) Int. Cl. G06F 11/00

(52) U.S. Cl. 714/11

(57) ABSTRACT

A server crash recovery reboot auto activation method and system is proposed, which is designed for use with a network server to allow the network server to automatically undergo a reboot procedure in the event of a system crash to the network server for automatic crash recovery of the network server without human intervention. The proposed method and system is characterized by the direct utilization of a watchdog timer in an I/O control chip already installed on the network server for the activation of an SMI (System Management Interrupt) based reboot procedure. This feature allows a cost-effective solution to the need for an auto system crash recovery capability on a network server. Moreover, since the proposed method and system relies on SMI (System Management Interrupt), and not IRQ (Interrupt ReQuest), it can notwithstanding initiate a reboot procedure even though the operating system of the network server fails.

### BACKGROUND OF THE INVENTION

1. Field of the Invention

This invention relates to network server technology, and more particularly, to a server crash recovery reboot auto activation method and system which is designed for use with a network server to allow the network server to automatically undergo a reboot procedure in the event of a system crash to the network server for automatic crash recovery of the network server back to normal operation without human intervention.

2. Description of Related Art

A network server is a network-linked computer platform that is used to provide data services to clients via network. In the event of a system crash to the network server, all clients will not be able to gain access to the data in the server. For this sake, it is an important task to reboot a crashed network server as soon as possible so as to resume the network server back to normal operation.

When a system crash occurs in a network server, a conventional way to resume the crashed network server back to normal operation is to manually reset the main system unit of the server by the network management personnel to thereby activate the server to undergo a reboot procedure. One drawback to this practice, however, is that the it may take some time for the system management personnel to perceive the problem and come in person to the server to manually reset the crashed server to undergo the reboot procedure, which is undoubtedly an inefficient way for crash recovery of the network server, and any delay in the recovery of the crashed server might cause loss in business transactions if the server is business-oriented.

One solution to the aforementioned problem is to install a server crash recovery reboot auto activation system on the network server, which can automatically respond to the condition of a system crash to the network server to thereby automatically activate a reboot procedure to reboot the operating system of the crashed server for the purpose of resuming the crashed server back to normal operation.

FIG. 1 is a schematic diagram showing the architecture of a conventional server crash recovery reboot auto activation system (as the part enclosed in the dotted box indicated by the reference numeral 100). As shown, this server crash recovery reboot auto activation system 100 is designed for use with a network server 10 equipped with a main system unit 20 (i.e., the assemblage of CPU and related hardware) running a server-specific operating system (OS) 30 for the purpose of automatically activating a reboot procedure to the network server 10 in the even of a system crash to the network server 10 due to a failure in the main system unit 20 or in the operating system 30. The server crash recovery reboot auto activation system 100 comprises: (a) a system crash responding module 110; (b) a watchdog timer 120; and (c) an IRQ (Interrupt ReQuest) handling module 130.

The system crash responding module 110 is coupled to the operating system 30 of the network server 10 and is capable of responding to the current operating condition of the network server 10 at predefined intervals to thereby generate a normal-operation indicative message to the watchdog timer 120. More specifically, if the network server 10 operates normally, the system crash responding module 110 will issue a normal-operation indicative message to the watchdog timer 120 in real time; whereas if a system crash occurs in the network server 10, the system crash responding module 110 will issue no normal-operation indicative message to the watchdog timer 120.

The watchdog timer 120 is capable of being activated in response to the presence of each normal-operation indicative message from the system crash responding module 110 to start counting time for a predefined timeout length, such as 59 seconds, and capable of being reset to original count at the presence of the next normal-operation indicative message from the system crash responding module 110 before reaching timeout. In the event of the timeout of the watchdog timer 120 (i.e., overflow of the most significant bit in the count at the 60th second in the case of a timeout length of 59 seconds), it will generate a system crash indicative IRQ signal to the IRQ handling module 130.

The IRQ handling module 130 is capable of being activated in response to the IRQ signal from the watchdog timer 120 to issue a reset signal RESET to the main system unit 20 of the network server 10, causing the main system unit 20 to undergo a reboot procedure to reboot the operating system 30 and thereby resume the crashed network server 10 back to normal operation.

One drawback of the foregoing server crash recovery reboot auto activation system 100, however, is that it is embodied as an externally-coupled circuit board to the network server 10, and therefore the utilization thereof requires extra cost to make or purchase the circuit board, which is undoubtedly an cost-ineffective solution for auto system crash recovery.

In addition, another drawback of the foregoing server crash recovery reboot auto activation system 100 is that it relies on the operating system 30 to handle the IRQ signal to initiate the reboot procedure, and therefore, in the event of a failure to the operating system 30, it would be impossible to initiate the reboot procedure for crash recovery of the network server 10.

### SUMMARY OF THE INVENTION

It is therefore an objective of this invention to provide a server crash recovery reboot auto activation method and system which allows a network server to have an auto system crash recovery capability without having to install extra hardware/software facilities on the network server so as to provide a cost-effective solution of auto system crash recovery for network management.

It is another objective of this invention to provide a server crash recovery reboot auto activation method and system which can be implemented without using IRQ signals.

The server crash recovery reboot auto activation method and system according to the invention is designed for use with a network server to allow the network server to automatically undergo a reboot procedure in the event of a system crash to the network server for automatic crash recovery of the network server back to normal operation without human intervention.

The server crash recovery reboot auto activation method and system according to the invention is characterized by the direct utilization of a watchdog timer in an I/O control chip already installed on the network server for the activation of an SMI-based reboot procedure (rather than IRQ-based reboot procedure as in the case of the prior art).

Compared to the prior art, since the invention utilizes existing hardware/firmware facilities (for example, Super I/O chip and Southbridge chip) on the network server with the add-in of only an SMI judgment procedure to the BIOS of the network server, it allows a cost-effective solution to the need for a auto system crash recovery capability on a network server. Moreover, since the invention relies on SMI (System Management Interrupt), and not IRQ (Interrupt ReQuest), it can notwithstanding initiate a reboot procedure even though the operating system of the network server fails.

### BRIEF DESCRIPTION OF DRAWINGS

The invention can be more fully understood by reading the following detailed description of the preferred embodiments, with reference made to the accompanying drawings, wherein:

FIG. 1 (PRIOR ART) is a schematic diagram showing the architecture of a conventional server crash recovery reboot auto activation system; and

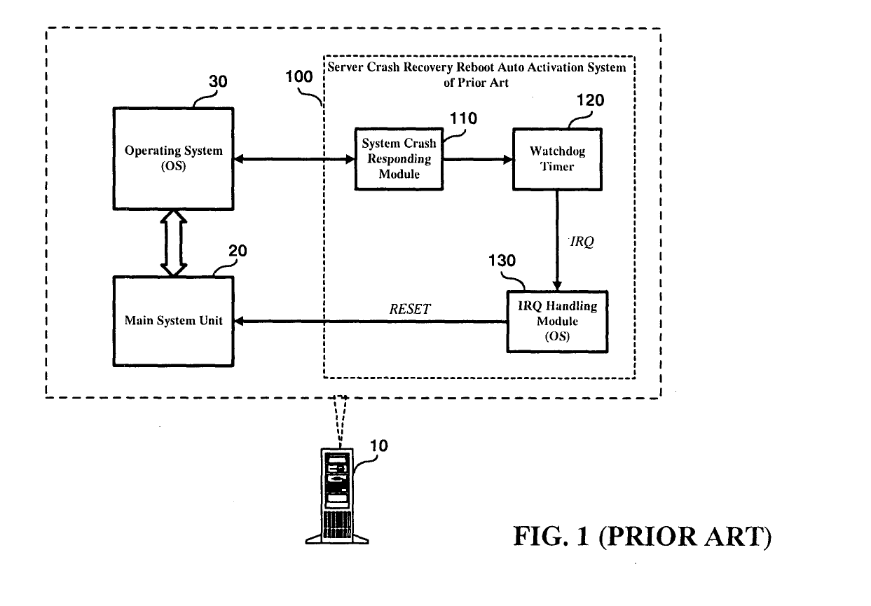

FIG. 2 is a schematic diagram showing an object-oriented component model of the server crash recovery reboot auto activation system according to the invention.

### DETAILED DESCRIPTION OF PREFERRED EMBODIMENTS

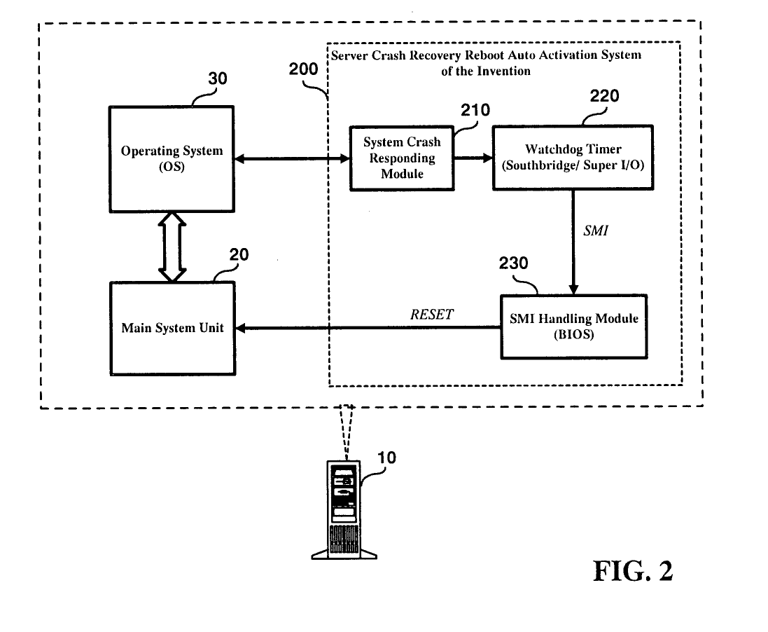

The server crash recovery reboot auto activation method and system according to the invention is disclosed in full details by way of preferred embodiments in the following with reference to FIG. 2.

FIG. 2 is a schematic diagram showing an object-oriented component model of the server crash recovery reboot auto activation system of the invention (as the part enclosed in the dotted box indicated by the reference numeral 200). As shown, the server crash recovery reboot auto activation system of the invention 200 is designed for use with a network server 10 having a main system unit 20 (i.e., the assemblage of CPU and related hardware) running a server-specific operating system (OS) 30 for the purpose of automatically activating the network server 10 to undergo a reboot procedure in the even of a system crash to the network server 10 due to a failure in the main system unit 20 or operating system 30 for crash recovery of the network server 10 back to normal operation.

The server crash recovery reboot auto activation system of the invention 200 comprises: (a) a system crash responding module 210; (b) a watchdog timer 220; and (c) a SMI (System Management Interrupt) handling module 230.

The system crash responding module 210 is coupled to the operating system 30 of the network server 10 and is capable of responding to the current operating condition of the network server 10 at predefined intervals to thereby generate a normal-operation indicative message to the watchdog timer 220. More specifically, if the network server 10 operates normally, the system crash responding module 210 will issue a normal-operation indicative message to the watchdog timer 220 in real time; whereas if a system crash occurs in the network server 10, the system crash responding module 210 will issue no normal-operation indicative message to the watchdog timer 220.

The watchdog timer 220 is preferably embodied in such a manner as to utilize the built-in watchdog timer in an I/O control chip installed on the network server 10, such as a Southbridge chip or a Super I/O chip, and which is capable of being activated in response to the presence of each normal-operation indicative message from the system crash responding module 210 to start counting time for a predefined timeout length, such as 59 seconds, and capable of being reset to original count at the presence of the next normal-operation indicative message from the system crash responding module 210 before reaching timeout. In the event of the timeout of the watchdog timer 220 (i.e., overflow of the most significant bit in the count at the 60th second in the case of a timeout length of 59 seconds), i.e., no normal-operation indicative message appears during the elapsed period of the predefined timeout length, the watchdog timer 220 will generate a system crash indicative SMI (System Management Interrupt) signal to the SMI handling module 230.

The SMI handling module 230 is preferably embodied in such a manner as to utilize the built-in SMI handling module in the I/O control chip installed on the network server 10, such as a Southbridge chip or a Super I/O chip, and which is capable of activating an SMI judgment procedure in the BIOS of the network server 10 to judge whether the currently received SMI signal is issued from the watchdog timer 220; if YES, the SMI handling module 230 promptly activates a BIOS-based reboot procedure to reboot the network server 10, whereby the main system unit 20 is reset and the operating system 30 is reloaded to resume the network server 10 back to normal operation.

In actual application, the server crash recovery reboot auto activation system of the invention 200 operates in such a manner that the system crash responding module 210 therein will respond to the current operating condition of the network server 10 at predefined intervals in such a manner that the system crash responding module 210 issues a normal-operation indicative message to the watchdog timer 220 if the network server 10 operates normally, and issues no normal-operation indicative message to the watchdog timer 220 if the network server 10 fails to operate normally (i.e., a system crash occurs). In response to the presence of each normal-operation indicative message from the system crash responding module 210, the watchdog timer 220 will be activated to start counting from origin value for a predefined timeout length; but if the next normal-operation indicative message is received from the system crash responding module 210 before the watchdog timer 220 reaches timeout, the watchdog timer 220 will be reset to original count. In the event of the timeout of the watchdog timer 220, the watchdog timer 220 will promptly generate a system crash indicative SMI (System Management Interrupt) signal to the SMI handling module 230. In response to the SMI signal from the watchdog timer 220, the SMI handling module 230 is first activated to initiate an SMI judgment procedure in the BIOS of the network server 10 to judge whether the currently received SMI signal is issued from the watchdog timer 220; if YES, the SMI handling module 230 promptly activates a BIOS-based reboot procedure to thereby reboot the network server 10, whereby the main system unit 20 is reset and the operating system 30 is reloaded to resume the crashed network server 10 back to normal operation.

In conclusion, the invention provides a server crash recovery reboot auto activation method and system for use on a network server to allow the network server to automatically undergo a reboot procedure in the event of a system crash to the network server for automatic crash recovery of the network server back to normal operation without human intervention. The server crash recovery reboot auto activation method and system according to the invention is characterized by the direct utilization of a watchdog timer in an I/O control chip already installed on the network server for the activation of an SMI-based reboot procedure (rather than IRQ-based reboot procedure as in the case of the prior art). Compared to the prior art, since the invention utilizes existing hardware/firmware facilities (for example, Super I/O chip and Southbridge chip) on the network server with the add-in of only an SMI judgment procedure to the BIOS of the network server, it allows a cost-effective solution to the need for a auto system crash recovery capability on a network server. Moreover, since the invention relies on SMI (System Management Interrupt), and not IRQ (Interrupt ReQuest), it can notwithstanding initiate a reboot procedure even though the operating system of the network server fails. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

1. A server crash recovery reboot auto activation method for use on a network server for automatically activate the network server to undergo a reboot procedure in the event of a system crash to the network server;
the server crash recovery reboot auto activation method comprising:
responding to the current operating condition of the network server at predefined intervals to thereby generate a normal-operation indicative message if the network server operates normally, and generate no normal-operation indicative message if the network server fails to operate normally;
at each presence of one normal-operation indicative message, start a timing procedure to count time for a predefined timeout length, and then at the presence of the next normal-operation indicative message, resetting the current time count to origin; and in the event of no presence of normal-operation indicative message during the elapsed period of the predefined timeout length, generating a System Management Interrupt signal; and
in response to the System Management Interrupt signal, activating a BIOS-based reboot procedure to thereby reboot the network server.

2. The server crash recovery reboot auto activation method of claim 1, wherein the timing procedure is performed by a watchdog timer in an I/O control chip installed on the network server.

3. The server crash recovery reboot auto activation method of claim 2, wherein the I/O control chip is a Super I/O chip.

4. The server crash recovery reboot auto activation method of claim 2, wherein the I/O control chip is a Southbridge chip.

5. A server crash recovery reboot auto activation system for use with a network server for automatically activate the network server to undergo a reboot procedure in the event of a system crash to the network server;
the server crash recovery reboot auto activation system comprising:
a system crash responding module, which is capable of responding to the current operating condition of the network server at predefined intervals to thereby generate a normal-operation indicative message if the network server operates normally, and generate no normal-operation indicative message if the network server fails to operate normally;
a watchdog timer, which is capable of being activated in response to the presence of each normal-operation indicative message from the system crash responding module to start counting time from an original count for a predefined timeout length, and capable of being reset to original count at the presence of the next normal-operation indicative message from the system crash responding module, and which is capable of generating a system crash indicative System Management Interrupt signal when reaching timeout in the event of no normal-operation indicative message being received during the elapsed period of the predefined timeout length; and
a System Management Interrupt handling module, which is capable of being activated in response to the System Management Interrupt signal from the watchdog timer to initiate a System Management Interrupt judgment procedure to judge whether the System Management Interrupt signal is issued from the watchdog timer; if YES, the System Management Interrupt handling module activating a BIOS-based reboot procedure to thereby reboot the network server.

6. The server crash recovery reboot auto activation system of claim 5, wherein the watchdog timer is a built-in functional module in an I/O control chip installed on the network server.

7. The server crash recovery reboot auto activation system of claim 6, wherein the I/O control chip is a Super I/O chip.

8. The server crash recovery reboot auto activation system of claim 6, wherein the I/O control chip is a Southbridge chip.

9. The server crash recovery reboot auto activation system of claim 5, wherein the System Management Interrupt handling module is a built-in functional module in an I/O control chip installed on the network server.

10. The server crash recovery reboot auto activation system of claim 5, wherein the System Management Interrupt judgment procedure is a built-in procedure in the BIOS of the network server.
